(19) United States
(12) Patent Application Publication
(10) Pub. No.: US 2022/0326909 A1
(43) Pub. Date: Oct. 13, 2022

(54) TECHNIQUE FOR BIT UP-CONVERSION WITH SIGN EXTENSION

(71) Applicant: TEXAS INSTRUMENTS INCORPORATED, Dallas, TX (US)

(72) Inventors: Anshu JAIN, Bengaluru (IN); Kumar DESAPPAN, Bengaluru (IN)

(21) Appl. No.: 17/714,327

(22) Filed: Apr. 6, 2022

(30) Foreign Application Priority Data
Apr. 9, 2021 (IN) 202141016812

(51) Int. Cl. G06F 7/499; G06F 7/483; G06F 5/01

(52) U.S. Cl. CPC G06F 7/49994; G06F 7/483; G06F 5/015

(57) ABSTRACT

A technique for bit depth up-conversion including obtaining an input value for a computation in a first bit depth with a fewer number of bits as compared to a second bit depth, converting the input value from the first bit depth to the second bit depth as an unsigned data value, adjusting a pointer to the converted input value based on the first bit depth, performing the computation based on the adjusted pointer to obtain an adjusted output value, and performing a right shift operation on the adjusted output value based on the first bit depth to obtain an output value.

### CROSS-REFERENCE TO RELATED APPLICATIONS

This application claims priority to India Provisional Application No. 202141016812, filed Apr. 9, 2021, which is hereby incorporated by reference.

### BACKGROUND

Generally, computers perform computations using binary numbers of a certain length. Increasing the length (e.g., bit depth) of the binary numbers used for those computations potentially increases an amount of precision available. For example, an 8-bit binary number is only able to represent 256 different values (e.g., 0-255, −128-127, etc.), while a 16-bit binary number may represent 65,536 values (e.g., 0-65,535, −32768-32767, etc.). Generally, to support both positive and negative numbers (e.g., signed numbers) in binary, the most significant bit (e.g., the left most bit) represents the sign, and thus 1000001 in signed 8-bit binary may represent −127 in decimal while 0000001 in signed 8-bit binary may represent 1 in decimal. Techniques for efficiently converting binary numbers from a lower bit depth to a higher bit depth (e.g., bit up-conversion) while maintaining a sign of the number may be useful.

### SUMMARY

This disclosure relates to a method. The method includes obtaining an input value for a computation in a first bit depth with a fewer number of bits as compared to a second bit depth. The method also includes converting the input value from the first bit depth to the second bit depth as an unsigned data value. The method further includes adjusting a pointer to the converted input value based on the first bit depth. The method also includes performing the computation based on the adjusted pointer to obtain an adjusted output value and performing a right shift operation on the adjusted output value based on the first bit depth to obtain an output value.

Another aspect of the present disclosure relates to a device. The device includes a memory controller configured to obtain an input value for a computation in a first bit depth with a fewer number of bits as compared to a second bit depth. The memory controller is further configured to convert the input value from the first bit depth to the second bit depth as an unsigned data value. The memory controller is also configured to adjust a pointer to the converted input value based on the first bit depth. The device further includes a processor operatively coupled to the memory controller, wherein the one or more processors are configured to execute instructions. The instructions cause the one or more processors to perform the computation based on the adjusted pointer to obtain an adjusted output value and perform a right shift operation on the adjusted output value based on the first bit depth to obtain a signed output value

Another aspect of the present disclosure relates to a non-transitory program storage device comprising instructions stored thereon to cause a memory controller to obtain an input value for a computation in a first bit depth with a fewer number of bits as compared to a second bit depth. The instructions further cause the memory controller to convert the input value from the first bit depth to the second bit depth as an unsigned data value. The instructions also cause the memory controller to adjust a pointer to the converted input value based on the first bit depth. The instructions further cause one or more processors operatively coupled to the memory controller to perform the computation based on the adjusted pointer to obtain an adjusted output value and perform a right shift operation on the adjusted output value based on the first bit depth to obtain a signed output value.

### BRIEF DESCRIPTION OF THE DRAWINGS

For a detailed description of various examples, reference will now be made to the accompanying drawings in which:

FIG. 1 illustrates a example ML network, in accordance with aspects of the present disclosure.

FIG. 2 is a block diagram illustrating a device, in accordance with aspects of the present disclosure.

FIG. 3 is a block diagram illustrating a data flow for a technique for bit up-conversion with sign extension, in accordance with aspects of the present disclosure.

FIG. 4 is a block diagram illustrating a variant of the technique for bit up-conversion with sign extension, in accordance with aspects of the present disclosure.

FIG. 5 is a flow diagram illustrating a technique for bit up-conversion with sign extension, in accordance with aspects of the present disclosure.

The same reference number is used in the drawings for the same or similar (either by function and/or structure) features.

### DETAILED DESCRIPTION

Generally, demand for efficient computing is increasing as more devices are being used where access to power may be limited. As an example, efficiency may be a more important design criteria in a battery powered device as compared to another device that is plugged in to a power outlet. To help increase efficiency, certain computations may be simplified to help reduce an amount of computational power needed. For example, performing certain computations at an 8-bit precision level may help reduce an amount of power needed by a processor to perform those computations as compared to performing those same computations at a 16-bit precision level. In many cases, this change in the bit depth of the computation may not substantially impact performance (e.g., accuracy) of a program using those computations. For example, a certain program, such as a ML program, may perform well when most of the computations of the program are executed at a lower bit depth (e.g., 8-bit) and a few of the computations of the program are executed at a higher bit depth (e.g., 16-bit). In such cases, it may be beneficial to optimize the program and reduce the bit depth of the computations when performing some computations. In some cases, performance of certain computations may be substantially impacted by the reduction of the bit depth and in such cases, it may be useful to increase the bit depth for those computations.

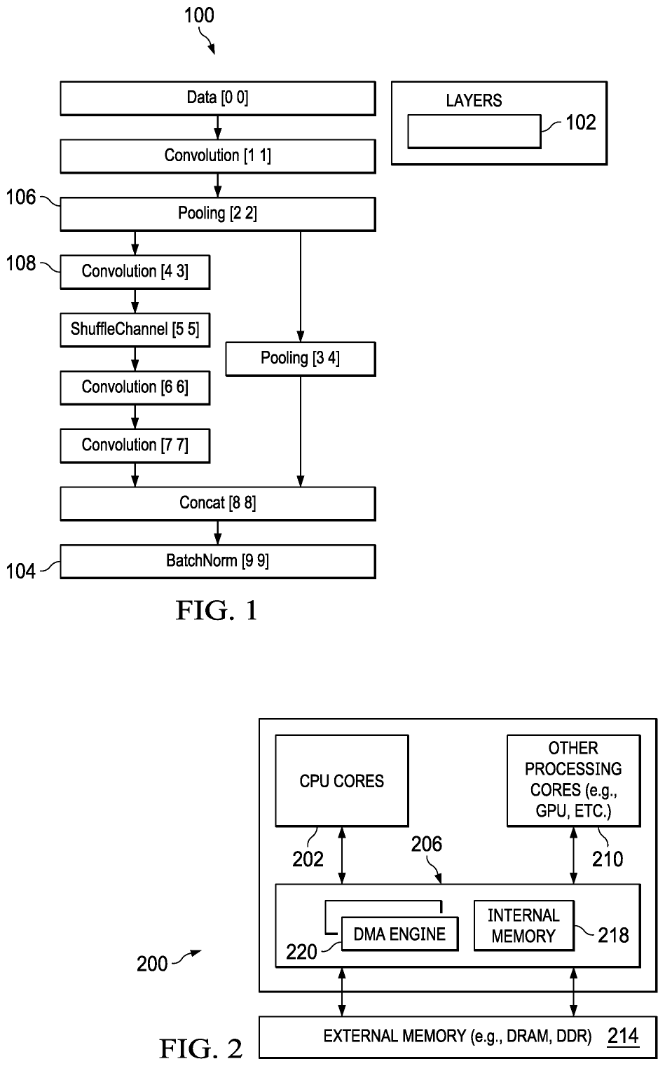

As a more specific example shown in FIG. 1, a machine learning (ML) network 100, such as a deep learning network, may include multiple layers 102 which may perform a variety of operations. For example, a certain deep learning network may include one or more convolution layers, pooling layers, concatenation layers, normalization layers, etc. In some cases, processing certain layers, such as a normalization 104, pooling layer 106, etc., using 8-bit inputs may not substantially impact the overall results and/or accuracy of the deep learning network. Thus, pooling layer 106 may be configured to accept 8-bit input and generate 8-bit output. This 8-bit output of the pooling layer 106 may then be input to another layer, such as a convolution layer 108. This convolution layer 108 may benefit from increased precision available from 16-bit computation and output, as compared to 8-bit. The 8-bit output of the pooling layer 106 may be bit up-converted to 16-bit for input to the convolution layer 108. If the output (e.g., 8-bit output of pooling layer 106) is signed then the bit up-conversion process should include sign extension to maintain the sign of the output being up-converted.

In some cases, the hardware performing the up-conversion process, such as a processor, may include one or more electronic circuits dedicated to performing the up-conversion process with sign extension. However, hardware support for up-conversion with sign extension may use more physical space on an integrated circuit (IC) as compared to just supporting the up-conversion without sign extension. Alternatively; the up-conversion with sign extension may be performed as a part of a computation process. For example, the up-conversion with sign extension may be performed as a part of processing a particular ML layer. However, adding an up-conversion step as a part of computation for particular layers may require code modifications to the ML layers, which may be difficult with third party ML models. Additionally. whether such code modifications will actually be more efficient can be dependent on the specific code implementation. Techniques discussed herein help allow an electronic circuit configured to perform an unsigned bit up-conversion more efficiently perform a bit up-conversion with sign extension.

Of note, in many cases, the computations performed by layers of ML models involve linear computations. More particularly, the computations may be linear homogeneous functions with a degree of one. That is, if input to a particular layer of the ML model is scaled by an amount S, then the output is also scaled by the amount S. Dividing the output by S can then restore the intended output, According to aspects of the present disclosure, optimization techniques for bit up-conversion with sign extension may be applied for linear computations executed on hardware supporting bit up-conversion without sign extensions.

FIG. 2 is a block diagram 200 illustrating a device, in accordance with aspects of the present disclosure. The device may be system on a chip (SoC) including multiple components configured to perform different tasks. As shown, the device includes one or more central processing unit (CPU) cores 202. The CPU cores 202 may be configured for general computing tasks.

The CPU cores 202 may be coupled to a crossbar (e.g., interconnect) 206, which interconnects and routes data between various components of the device. In some cases, the crossbar 206 may be a memory controller or any other circuit that can provide an interconnect between peripherals. Peripherals may include master peripherals (e.g., components that access memory, such as various processors, processor packages, direct memory access/input output components, etc.) and slave peripherals (e.g., memory components, such as double data rate random access memory, other types of random access memory, direct memory access/input output components, etc.). In this example, the crossbar 206 couples the CPU cores 202 with other peripherals, such as other processing cores 210, (e.g., graphics processing unit, machine learning core, radio basebands, coprocessors, microcontrollers, etc.) and external memory 214, such as double data rate (DDR) memory, dynamic random access memory (DRAM), flash memory, etc., which may be on a separate chip from the SoC. The crossbar 206 may include or provide access to one or more internal memories 218 that may include any type of memory, such as static random access memory (SRAM), flash memory, etc.

To help facilitate the CPU cores 202, other processing cores 210, and/or other memory accessing peripherals access memory, the crossbar may include one or more direct memory access (DMA) engines 220. The DMA engines 220 may be used by applications, such as ML models, to perform memory operations and/or to offload memory management tasks from a processor. These memory operations may be performed against internal or external memory. When a ML model is executing on a processing core (e.g., CPU cores 202 or other processing cores 210), the ML model may store and/or access data for executing a ML layer of the ML model in a memory using one or more DMA engines 220. In some cases, the DMA engines 220 may abstract the memory access such that the ML model accesses a memory space controlled by the DMA engines 220 and the DMA engines 220 determines how to route the memory access requests from the ML model.

The DMA engines 220 may support bit up-conversion without sign extension. For example, the DMA engines 220 may be configured to support bit up-conversion without sign extension by being configured to place a received 8-bit memory write, such as an output from a first layer of a ML model, into a 16-bit memory allocation and zero-filling the higher-level bits (e.g., bits 9-16). This 16-bit value may then be used as input to a second layer of the ML model. In some cases, the up-conversion as a part of a memory write may be performed without incurring memory access cycles as compared to a memory write without up-conversion as the zero-fill operation may be performed as a part of the memory write. While bit up-conversion without sign extension is described in the context of a DMA engine, other processors and/or circuits may be configured to perform the bit up-conversion without sign extension.

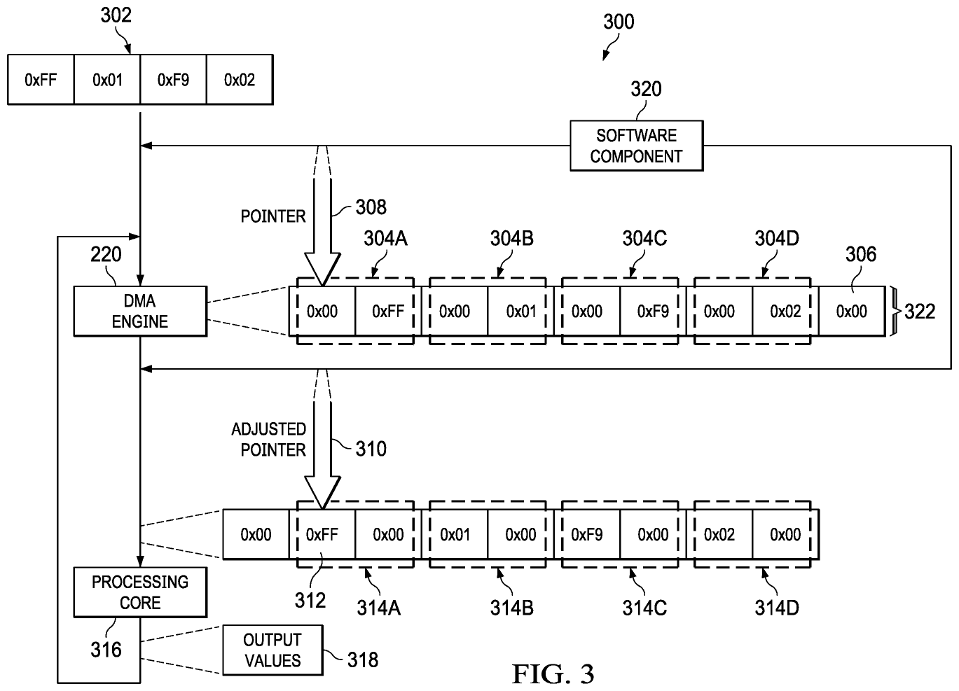

FIG. 3 is a block diagram 300 illustrating a data flow for a technique for bit up-conversion with sign extension, in accordance with aspects of the present disclosure. While in this example a DMA engine 220 is shown, it may be understood that the technique for bit up-conversion with sign extension may be performed by any electronic circuit capable of performing a bit up-conversion without sign extensions and accessing a memory. In some cases, the technique for signed bit up-conversion may be performed responsive to a bit and/or other indication received by the DMA engine 220. For example, the DMA engine 220 may receive an indication to perform the bit up-conversion with sign extension along with output of a first layer of an executing ML model. In some cases, the indication may be received from a process separate from the executing ML model.

In diagram 300, a set of one or more signed input values 302 are obtained by a DMA engine 220. These input values may be obtained in any known way. For example, the DMA engine 220 may receive an input value, for example, as a part of a memory write or read operation, or a reference to a memory location containing the input value, such as a pointer or memory address, may be received. As another example, for a ML model executing on a processor, a first layer of the ML model may output 8-bit, signed data. This data may be used as the input values 302 for a second layer of the ML model. As a part of preparing for and executing the calculations of the second layer of the ML model, the 8-bit signed data output from the first layer may be up-converted to 16-bit signed data for use by the second layer of the ML model. The up-conversion of the input data along with bit shifting, discussed below, and the calculations of the second layer may be performed in the context of a single layer (e.g., the second layer).

In some cases, a software component 320, such as an interface, adapter, controller, etc., may also be executing on the processor (or another processor or circuit on a system or device which includes multiple processors/cores/processing units, etc.) to help the ML model interface with the DMA engine 220 and/or other components of the system or device. This software component 320 may be used to help, for example, configure the DMA engine 220, determine, translate, and/or provide memory locations/addresses, pointers, etc. As a more specific example, the software component 320 may provide a memory address, such as pointer 308, indicating to the DMA engine 220 where to store the input values 302. In some cases, the DMA engine 220 may translate memory addresses from a logical address to one or more physical addresses. In some cases, the software component 320 may also indicate to the DMA engine 220 to perform an unsigned bit up-conversion of the signed input values 302. In some cases, the software component 320 may be integrated into a ML model, operating system, or other software executing on a device or system.

The obtained set of signed input values 302 may then be bit up-converted from a first bit depth (e.g., 8-bit) to a second bit depth (e.g., 16-bit) as unsigned data values 322. While the examples discussed herein illustrate an up-conversion from 8-bit binary data values to 16 bit binary data values, it may be understood that the techniques discussed herein may apply to up-conversions involving other bit sizes, such as 8-bit to 32-bit, 16-bit to 32-32 bit, etc. In the example illustrated in diagram 300, the set of input values 302 may include signed 8-bit binary values, such as 0xFF, 0x01, 0xF9, and 0x02 (shown here as hex values for readability). In some cases, the set of input values 302 may be the output of a first ML layer. These 8-bit values may be up-converted to, for example, 16-bit unsigned values by placing the 8-bit values in a 16-bit memory space and zero filling the 8 most significant bits. For example, in a system having a memory organized using big endian with number values stored from largest to smallest when read from left to right (e.g., from a most significant byte to a least significant byte from left to right), a signed 8-bit binary number 11111111 (where signed numbers are stored in two's complement format), corresponding to 0xFF (hex, −1 decimal), may be converted to 16-bit unsigned number by appending eight zeros to the left of the start of the number, or 0000000011111111 (255 decimal) and writing the converted value to a 16-bit memory space 304A. The pointer 308 indicates the beginning memory address, here memory space 304A. The DMA engine 302 may receive the pointer 308 and allocate one or more 16-bit memory spaces, such as 16-bit memory spaces 304A, 304B, 304C, and 304D (collectively 304). In this example, 16-bit memory space 304A is shown as two 8-bit spaces for clarity purposes and the larger memory space (e.g., 16-bit memory space) need not be made up of smaller sized memory spaces (e.g., 8-bit memory spaces). Memory space 304B is shown with the up-converted value for 0x01, memory space 304C with the up-converted value for 0xF9, and memory space 304D with the up-converted value for 0x02.

An additional memory space 306 may be allocated. This additional memory space 306 may be allocated after the 16-bit memory allocation(s). In this example, the additional memory space 306 is allocated after memory space 304D. The additional memory space 306 is zero filled. In some cases, the zero-fill may be performed in software, such as the software component 320, executing on a processor. For example, the software component 320 may provide, to the DMA engine 220 an ending memory address, indicating to the DMA engine 220 to allocate the memory space for the up-converted values plus the additional memory space 306. The software component 320 may also perform the zero-fill operation for the additional space 306. In some cases, the additional memory space 306 may be zero filled initially and then used for multiple processes, such as across multiple layers of the ML model, without being zero-filled again. A size of this additional space may be based on a difference between a size of the first bit depth to a size of the second bit depth. In this example, the additional memory space 306 may be 8-bits (e.g., the difference between a number of bits in a 16-bit value and an 8-bit value).

In some cases, the software component 320 may adjust the pointer 308 to generate an adjusted pointer 310. In some cases, the software component may adjust the pointer based on whether the data output, for example by a first layer, is signed and if the data to be input, for example to the second layer, is also signed and a bit up-conversion is needed. In some cases, the pointer adjustment may occur in kernel software and the software component 320 may call into the kernel software to adjust the pointer. The pointer adjustment may be based on the difference between the size of the first bit depth and the size of the second bit depth. In this example, the pointer 308 may be adjusted by 8 bits and the adjusted pointer 310 points to the beginning of the initial 8-bit binary value portion 312 (having a value of 0xFF) of adjusted 16-bit memory allocation 314A. This adjusted pointer 310 shifts the 16-bit memory allocation such that the adjusted memory allocation 314A includes the least significant 8-bits of memory allocation 304A (0xFF) and the most significant 8-bits of memory allocation 304B (0x00). In this example, the converted value, 0000000011111111, stored in memory space 304A is adjusted to have a value of 1111111100000000 in adjusted memory allocation 314A. This adjusted value now has a sign corresponding to the input value before conversion as compared to the unsigned converted value. The adjustment of the pointer effectively applies a left shift, here, by 8-bits. This left shift has an effect of multiplying the input value before conversion by a factor, here a factor of 256 (e.g., 8 bits). Similarly, adjusted memory allocation 314B includes portions of memory allocations 304B and 304C and adjusted memory allocation 314C includes portions of memory allocations 304C and 304D. Adjusted memory allocation 314D includes a portion of memory allocation 304D along with the additional memory space 306. The zero filled additional memory space 306 helps avoid buffer overflow issues and allows the adjusted memory allocation 314D to access a memory space with known values. In some cases, the zero filled portion corresponding to the most significant bits of memory space 304A may be dropped.

The DMA engine 220 may pass the adjusted values, for example, based on the adjusted pointer 310 to a processing core 316 executing the second layer of the ML model. The DMA engine 220 may send the adjusted values stored in the adjusted memory allocations 314 to the processing core 316 executing the ML model. In some cases, the processing core 316 may correspond to any of the CPU cores 202 and/or other processing cores 210.

After receiving the adjusted pointer 310 and/or adjusted values stored in the adjusted memory allocations 314 the processing core 316 may perform computations based on the adjusted values stored in the adjusted memory allocations 314 and generate adjusted output values. For example, the processing core 316 executing the second layer of the ML model may perform the computations of the second layer on the adjusted values. As indicated above, as the computations are linear computations and the one or more results of the computations, e.g., the adjusted output values, are scaled by the same amount as the input. Thus, the one or more computation results are, in effect, multiplied by the same factor as applied to the adjusted input values, here 256, due to the adjusted pointer.

A right shift may then be applied to the one or more computation results. The right shift is of the same number of bits as the adjustment of the pointer and has the effect of dividing the one or more computation results by the same factor as applied to the adjusted input values, here 256. Additionally, the right shift is a signed operation and takes into account the sign of the one or more computation results. In some cases, this right shift may be performed by the processing core 316. For example, a change in the number of bits as between the output received from the first layer and the input to the second layer is anticipated and a right shift is often used as a part of the computation of the second layer to adjust the precision of the one or more computation results. In such cases, the right shift to correct for the adjusted input values may have little to no impact on a performance of the computation as compared to performance of the computation without the right shift to correct for the adjusted input values. An additional right shift and/or an adjustment to an existing right shift may be performed to correct for the adjusted input values and generate one or more output values 318 from the one or more computation results. The output values 318 may be passed to the DMA engine 220, for example, for storage and/or use by a third layer of the ML model.

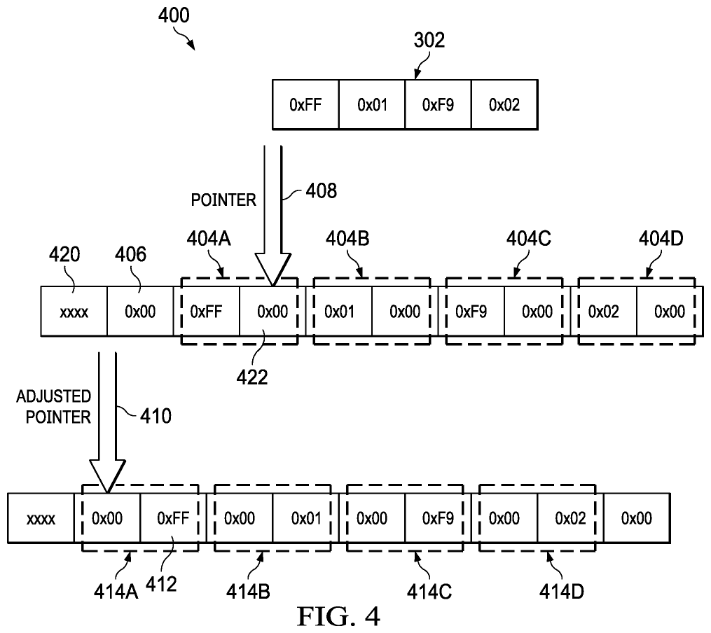

FIG. 4 is a block diagram 400 illustrating a variant of the technique for bit up-conversion with sign extension, in accordance with aspects of the present disclosure. As shown in diagram 400, the technique for bit up-conversion with sign extension applies similarly to systems having memory organized using little endian where number values stored from smallest to largest when read from left to right (e.g., from a least significant byte to a most significant byte from left to right such that a number such as 0000000011111111 is stored in memory as 11111111 00000000). In a little endian organization, the set of 8-bit input values 302 may also be up-converted to 16-bit unsigned values by placing the 8-bit input values in a 16-bit memory space and zero filling the 8 most significant bits (with the more significant bits on the right). In this example, for the set of 8-bit input values 302, memory space 402A is allocated for the up-converted value for 0xFF, memory space 404B is allocated for the up-converted value for 0x01, memory space 402C is allocated for the up-converted value for 0xF9, and memory space 402D is allocated for the up-converted value for 0x02. An additional memory space 406 may be allocated before the 16-bit memory allocations. A pad memory space 420 is added as well for a two byte (two 8-bit shifts) total shift. This pad memory space 420 may be added, for example, due to implementation specific limitations. The pad memory space 420 may or may not be zero filled.

Similarly, a pointer 408 indicating the start of the converted set of input values may be adjusted to shift the 16 bit memory allocation to advance the least significant bits. In this example, the pointer 408 points to memory space 422 at the beginning of memory space 404A due to the little endian memory organization. The pointer 408 may also be adjusted by 8 bits in this example to produce an adjusted pointer 410 pointing to the beginning of the initial 8-bit binary value portion 412 (having a value of 0xFF) of the 16-bit memory allocation. As shown the, adjusted memory allocation 414B includes portions of memory allocations 404A and 404B, adjusted memory allocation 414C includes portions of memory allocations 304B and 304C, and adjusted memory allocation 414D includes a portion of memory allocation 304C and 304D. The zero filled portion corresponding to the most significant bits of memory space 404D may be dropped. Computations made based on the adjusted memory allocations 414 may be performed in the same manner as described above in conjunction with FIG. 3.

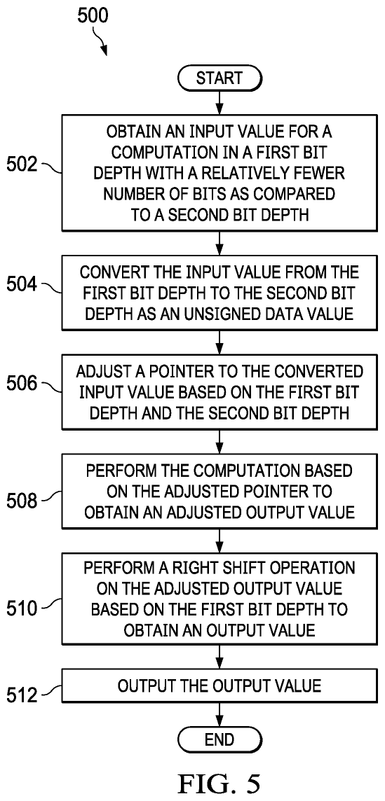

FIG. 5 is a flow diagram 500 illustrating a technique for bit up-conversion with sign extension, in accordance with aspects of the present disclosure. At block 502, an input value for a computation in a first bit depth with a fewer number of bits as compared to a second bit depth is obtained. For example, an electronic circuit, such as a memory access circuit or other circuit which supports unsigned bit up-converting may receive input values, such as values output by a first layer of a ML model. The input values may be in a bit depth, such as 8-bit depth, that has a fewer number of bits than another bit depth, such as 16-bit depth. In some cases, a determination to perform the bit up-conversion with sign extension may be made. For example, a software component may determine to perform the bit up-conversion with sign extension based on whether bit up-conversion between layers are needed, and whether the output of the first layer and input of the second layer are signed. In some cases, the determination to perform the signed bit up-conversion between layers may be predetermined, for example, prior to execution of the ML model on the device. In some cases, this indication may be received from a process executing a particular computation, such as an executing ML model. In other cases, this indication may be received from another process. For example, a ML model may be analyzed in a pre-execution phase to help prepare the ML model for execution with the electronic circuit. This analysis may help identify specific layers of the ML model which may benefit from techniques discussed herein and generate code, parameters, and/or other information that may be used to determine whether to perform and/or control the performance of the signed bit up-conversion between layers as the ML model is executed.

At block 504, the input value is converted from the first bit depth to the second bit depth as an unsigned data value. For example, the electronic circuit may be configured to perform an unsigned bit up-conversion. In some cases, the conversion may include allocating a memory space, the memory space sized based on the second bit depth and writing the input value to the allocated memory space. Portions of the allocated memory space may also be zero filled. In some cases, a size of the allocated memory space may be based on a number of bits in the second bit depth and a difference in a number of bits between the first bit depth and the second bit depth. For example, for a single 8-bit value being converted to 16-bit, the allocated memory size may be based on the 16-bit size as well as an 8-bit additional memory space. A pointer to the beginning of the allocated memory space may also be generated. At block 506, a pointer to the converted input value is adjusted based on the first bit depth. For example, the pointer to the beginning of the allocated memory space may be adjusted based on a difference in a number of bits between the first bit depth and the second bit depth. For example, the beginning of the allocated memory space for up-converting an 8-bit value to 16-bits may be adjusted by 8 bits. clarify for 16 bit case as well.

At block 508, the computation is performed based on the adjusted pointer to obtain an adjusted output value. In some cases, the computation may be performed by a processing core. For example, the DMA engine may provide the converted input values to the processing core as input for one or more computations associated with a second ML layer. These computations are linear computations. The adjusted pointer has the effect of multiplying the input values by a factor and the adjusted output of the computations may be multiplied by the factor. At block 510, a right shift operation is performed on the adjusted output value based on the first bit depth to obtain a signed output value. The right shift operation helps correct the generated adjusted output by the factor to produce an expected value that is signed. At block 512, the signed output value is output. For example, the signed output value may be output to the DMA engine to be written to a memory.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof. A circuit or device that is described herein as including certain components may instead be adapted to be coupled to those components to form the described circuitry or device. Modifications are possible in the described embodiments, and other embodiments are possible, within the scope of the claims.

What is claimed is:

1. A method, comprising:
obtaining an input value for a computation in a first bit depth with a fewer number of bits as compared to a second bit depth;
converting the input value from the first bit depth to the second bit depth as an unsigned data value;
adjusting a pointer to the converted input value based on the first bit depth;
performing the computation based on the adjusted pointer to obtain an adjusted output value; and
performing a right shift operation on the adjusted output value based on the first bit depth to obtain an output value.

2. The method of claim 1, wherein the converting is performed by an electronic circuit supporting unsigned bit up-converting.

3. The method of claim 2, wherein the electronic circuit comprises a memory access circuit and wherein the computation is performed by a processor.

4. The method of claim 1, wherein the pointer is adjusted based on a difference in a number of bits between the first bit depth and the second bit depth.

5. The method of claim 1, wherein the computation is a linear computation.

6. The method of claim 1, wherein the converting comprises:
allocating a memory space; and
writing the input value in the second bit depth to the allocated memory space;

7. The method of claim 6, wherein a size of the allocated memory space is based on a number of bits in the second bit depth and a difference in a number of bits between the first bit depth and the second bit depth.

8. A device comprising:
a memory controller configured to
obtain an input value for a computation in a first bit depth with a fewer number of bits as compared to a second bit depth;
convert the input value from the first bit depth to the second bit depth as an unsigned data value; and
adjust a pointer to the converted input value based on the first bit depth; and
a processor operatively coupled to the memory controller, wherein the one or more processors are configured to execute instructions causing the one or more processors to:
perform the computation based on the adjusted pointer to obtain an adjusted output value; and
perform a right shift operation on the adjusted output value based on the first bit depth to obtain a signed output value.

9. The device of claim 8, wherein the memory controller includes an electronic circuit to perform unsigned bit up-conversions.

10. The device of claim 8, wherein the pointer is adjusted based on a difference in a number of bits between the first bit depth and the second bit depth.

11. The device of claim 8, wherein the computation is a linear computation;

12. The device of claim 8, wherein the memory controller is configured to convert the input by value by
allocating a memory space; and
writing the input value in the second bit depth to the allocated memory space;

13. The device of claim 12, wherein a size of the allocated memory space is based on a number of bits in the second bit depth and a difference in a number of bits between the first bit depth and the second bit depth.

14. A non-transitory program storage device comprising instructions stored thereon to cause a memory controller to:
obtain an input value for a computation in a first bit depth with a fewer number of bits as compared to a second bit depth;
convert the input value from the first bit depth to the second bit depth as an unsigned data value; and
adjust a pointer to the converted input value based on the first bit depth; and
wherein the instructions further cause one or more processors operatively coupled to the memory controller to:
perform the computation based on the adjusted pointer to obtain an adjusted output value; and
perform a right shift operation on the adjusted output value based on the first bit depth to obtain a signed output value.

15. The non-transitory program storage device of claim 14, wherein the memory controller includes an electronic circuit to perform unsigned bit up-conversions.

16. The non-transitory program storage device of claim 14, wherein the pointer is adjusted based on a difference in a number of bits between the first bit depth and the second bit depth.

17. The non-transitory program storage device of claim 14, wherein the computation is a linear computation;

18. The non-transitory program storage device of claim 14, wherein the memory controller is configured to convert the input by value by allocating a memory space; and
writing the input value in the second bit depth to the allocated memory space;

19. The non-transitory program storage device of claim 18, wherein a size of the allocated memory space is based on a number of bits in the second bit depth and a difference in a number of bits between the first bit depth and the second bit depth.

20. The non-transitory program storage device circuit of claim 14, wherein the instructions further comprise instructions to cause a processor of the one or more processors to:
transmit an indication to the memory controller to convert the input value; and
transmit an indication to the processor to perform the right shift operation.
